(19) United States
(12) Patent Application Publication
(10) Pub. No.: US 2012/0231679 A1
(43) Pub. Date: Sep. 13, 2012

(54) AUDIO JACK CONNECTOR HAVING LOW INSERTION FORCE AND HIGH EJECTION FORCE

(75) Inventor: WEI-DE ZHANG, Shenzhen (CN)

(73) Assignee: HON HAI PRECISION INDUSTRY CO., LTD., New Taipei (TW)

(21) Appl. No.: 13/413,860

(22) Filed: Mar. 7, 2012

(30) Foreign Application Priority Data
Mar. 7, 2011 (CN) 201120057599.4

(51) Int. Cl. H01R 13/02

(52) U.S. Cl. 439/884

(57) ABSTRACT

An electrical contact (100) of an audio jack connector includes a main portion (10), a soldering portion (30) bending from a lateral edge of the main portion, an elastic portion (20) extending curvedly from a distal end of the main portion to be located above the main portion. The elastic portion has a flexible beam (21), a first arm (22) extending upwardly from the flexible beam and a second arm (23) curvedly bending from the first arm. The first arm and is consistent with a direction along which an audio plug connector is inserted. The second arm is adverse to a direction along which the audio plug connector is withdrawn.

### BACKGROUND OF THE INVENTION

1. Field of the Invention

The present invention relates generally to an audio jack connector, and more particularly to an audio jack connector having low insertion force and high ejection force.

2. Description of Related Arts

An audio jack connector is usually arranged on an electronic device and an audio plug connector is inserted into the audio jack connector for signal transmission. A user expects low insertion force for facilitating insertion of the audio plug connector. Additionally, high ejection force is expected because the audio jack connector is arranged on peripheral of the electronic device and the audio plug connector may be inadvertently withdrawn from the audio jack connector.

A conditional audio jack connector usually comprises a main portion, a soldering portion bending from an edge of the main portion, an elastic portion extending curvedly from an end of the main portion to be located above the main portion, and a contacting portion formed at the end of the elastic portion. The contacting portion has a first arm upwardly extending from the elastic portion, a curved portion at a highest position, and a second, free arm extending downwardly from the curved portion. The first arm and the second arm are respectively located at opposite sides of the curved portion and the contacting portion defines an opening properly facing to the main portion. The first arm is oblique to be consistent with a first direction along which an audio plug connector is inserted. Therefore, the audio plug connector is guided by the first arm when it is inserted into the audio jack connector. The second arm is oblique, too and is consistent with a second direction along which the audio plug connector is withdrawn. Therefore, the audio plug connector is guided by the second arm when it is withdrawn from the audio jack connector. Generally speaking, the audio jack connector has a low insertion force into which the audio plug connector is conveniently inserted; the audio jack connector also has a low ejection force, resulting in that the audio plug connector may be inadvertently withdrawn from the audio jack connector.

Hence, an audio jack connector which has a low insertion force and a high ejection force is desired.

### SUMMARY OF THE INVENTION

Accordingly, an object of the present invention is to provide an audio jack connector which has a low insertion force and a high ejection force.

To achieve the above object, an electrical contact of an audio jack connector includes a main portion, a soldering portion bending from a lateral edge of the main portion, an elastic portion extending curvedly from a distal end of the main portion to be located above the main portion. The elastic portion has a flexible beam, a first arm extending upwardly from the flexible beam and a second arm curvedly bending from the first arm. The first arm and is consistent with a direction along which an audio plug connector is inserted. The second arm is adverse to a direction along which the audio plug connector is withdrawn.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical contact of an audio jack connector in a preferred embodiment of the present invention;

FIG. 2 is a front elevational view of the electrical contact in a natural state; and

FIG. 3 is a front elevational view of the electrical contact when an audio plug connector is inserted.

### DETAILED DESCRIPTION OF THE PREFERRED EMBODIMENT

Reference will now be made in detail to the preferred embodiment of the present invention.

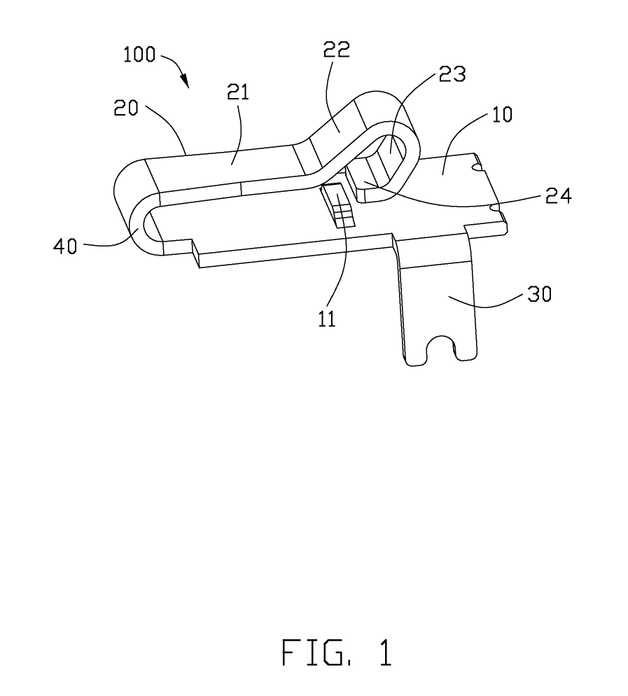

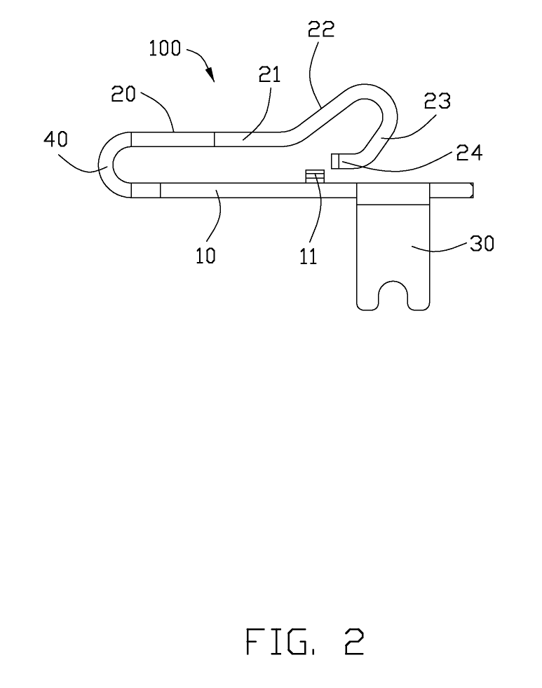

Referring to FIGS. 1 and 2, an electrical contact 100 of an audio jack connector (not shown) comprises a main portion 10, a soldering portion 30 bending from a lateral edge of the main portion 10, and an elastic portion 20 extending curvedly from a distal end of the main portion 10 to be located above the main portion 10. The elastic portion 20 has a flexible beam 21 parallel to the main portion 10, a first arm 22 extending upwardly from the flexible beam 21, and a second arm 23 curvedly bending from the first arm 22. The first arm 22 and the second arm 23 are both oblique and commonly form a contact section bulged beyond the flexible beam 21 for contact with the plug which is inserted into the housing of the audio jack under condition that the whole contact section essentially defines an arc extending over 270 degrees. The electrical contact 100 comprises an arc portion 40 connecting with the main portion 10 and the flexible beam 21. The electrical contact 100 further comprises a block portion 24 at a free end of the second arm 23 extending towards the arc portion 40. The block portion 24 extends parallel with the main portion 10 and is positioned between the main portion 10 and the elastic portion 20 along a vertical direction. The main portion 10 has a stamped protrusion 11 towards the elastic portion 20 to be pre-connected with the block portion 24. The protrusion 11 is positioned between the arc portion 40 and the block portion 24.

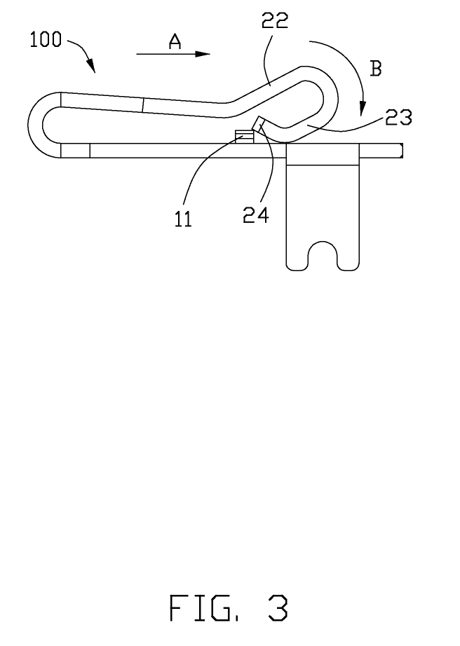

Referring to FIG. 3, when the audio plug connector is inserted into the audio jack connector along a first horizontal direction (shown as A), the elastic portion 20 rotates along a second semi-circumferential direction (shown as B). Therefore, the block portion 24 connects with the protrusion 11 and the audio plug connector is prevented from excessively insertion. Because a deformation of the elastic portion 20 is compliant with the direction along which the audio plug connector is inserted, the electrical contact 100 of the present invention provides a low insertion force; and the deformation of the elastic portion 20 is conversed to a direction along which the audio plug connector is withdrawn, a high ejection force is provided to meet the user's expectation.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical contact of an audio jack connector, comprising:
a main portion;
a soldering portion bending from a lateral edge of the main portion; and
an elastic portion extending curvedly from a distal end of the main portion to be located above the main portion, the elastic portion having a flexible beam, a first arm extending upwardly from the flexible beam and a second arm curvedly bending from the first arm;
wherein a deformation of the elastic portion is compliant with a direction along which an audio plug connector is inserted and the deformation of the elastic portion is converse to a direction along which the audio plug connector is withdrawn.

2. The electrical contact of an audio jack connector as claimed in claim 1 comprising a block portion, wherein a protrusion is stamped towards the elastic portion to be pre-connected with the block portion.

3. The electrical contact of an audio jack connector as claimed in claim 2, wherein the flexible beam extends parallel with the main portion.

4. The electrical contact of an audio jack connector as claimed in claim 2 comprising an arc portion connecting with the main portion and the elastic portion, wherein the protrusion is positioned between the arc portion and the block portion.

5. The electrical contact of an audio jack connector as claimed in claim 2, wherein the block portion is positioned between the main portion and the elastic portion along a vertical direction.

6. The electrical contact of an audio jack connector as claimed in claim 5, wherein the block portion extends parallel with the main portion.

7. An electrical contact for use with in an electrical connector, comprising:
a planar main portion adapted for retaining to a housing of the connector;
a front arc portion unitarily extending from a front end of the main portion initially upwardly and further toward a rear end of the main body; and
an elastic portion unitarily extending rearwardly from the front arc portion and spaced from the main body, said elastic portion including a flexible beam linked to the front arc portion, and a rear arc portion which is linked to the flexible beam and defines a contact section and essentially extends above the flexible beam for contact with a plug and adapted to abut against the main portion when the elastic portion is deflected toward the main portion; wherein
the front arc portion extends around 180 degrees to define rearward facing opening while the rear arc portion extends around 270 degrees to define a forwardly and downward facing opening.

8. The electrical contact as claimed in claim 7, wherein the front arc portion and the rear arc portion are spaced from each the via the flexible beam with a distance which is two times over a dimension of either the front arc portion and the rear arc portion along a front-to-back direction.

9. The electrical contact as claimed in claim 7, wherein a block portion is located at a free end of the contact section for abutment with a stamped protrusion on the main portion when the flexible beam is deflected toward the main portion.

10. The electrical contact as claimed in claim 7, wherein the flexible beam is essentially parallel to the main portion.

11. The electrical contact as claimed in claim 7, wherein a solder portion is formed on a rear region of the main portion.

12. The electrical contact as claimed in claim 11, wherein the solder portion is located behind the rear arc portion in a front-to-back direction.

13. The electrical contact as claimed in claim 7, wherein the contact section include a first arm with an outer surface facing forwardly and upwardly, and a second arm with another outer surface facing rearwardly.

14. An electrical contact for use with an electrical connector, comprising:
a planar main portion adapted for retaining to a housing of the connector;
a front arc portion unitarily extending from a front end of the main portion initially upwardly and further toward a rear end of the main body; and
an elastic portion unitarily extending rearwardly from the front arc portion and spaced from the main body, said elastic portion including a flexible beam linked to the front arc portion, and a rear arc portion which is linked to the flexible beam and defines a contact section and essentially extends above the flexible beam for contact with a plug and adapted to abut against the main portion when the elastic portion is deflected toward the main portion; wherein
the rear arc portion essentially extends initially rearwardly and upwardly and successively downwardly and further forwardly to define wholly a loop like configuration regardless of whether a forward opening remains around a free end of the rear arc portion or not; wherein
the front arc portion and the rear arc portion are spaced from each other via the flexible beam with a distance which is more than two times of a dimension of either the front arc portion and the rear arc portion in a front-to-back direction.

15. The electrical contact as claimed in claim 14, wherein the flexible beam is essentially parallel to the main portion.

16. The electrical contact as claimed in claim 14, wherein a block portion is located at a free end of the contact section for abutment with a stamped protrusion on the main portion when the flexible beam is deflected toward the main portion.
